(19) United States
(12) Patent Application Publication
(10) Pub. No.: US 2007/0100714 A1
(43) Pub. Date: May 3, 2007

(54) Method for billable timekeeping

(76) Inventor: David Andrew Walker, Carine (AU)

Correspondence Address: WOLF GREENFIELD & SACKS, PC, FEDERAL RESERVE PLAZA, 600 ATLANTIC AVENUE, BOSTON, MA, 02210-2206, US

(21) Appl. No.: 11/265,534

(22) Filed: Nov. 2, 2005

(51) Int. Cl. G06F 15/02

(52) U.S. Cl. 705/32

(57) ABSTRACT

A method for billable timekeeping using a computer is described. The method comprises generating a time input window corresponding to an event for receiving and recording a start time and an end time for the event against an identifier; comparing the start time and end time of the event with the start time and end time of another event for the identifier; and, generating a conflict resolution input window for selection of a conflict resolution option in the event of an overlap in duration between the event and the another event. Various different options exist for resolving the conflict by adjusting the start time or end time for one or both the event or the another event, truncation of the event or the other event to remove the conflict or distributing the overlap in duration between the event and the another event to remove the conflict.

### FIELD OF THE INVENTION

The present invention relates to a computer method, system and apparatus for tracking time against an identifier. The invention has been developed in the context of tracking time for activities against an employee, project or client identifier, and particularly though not exclusively in the context of corporate accounting or other effort related systems such as safety reporting. The present invention has broader application to other situations where time is recorded against a resource.

### BACKGROUND

The recording of time accurately is becoming increasingly important as a means for streamlining the invoicing of project costs to clients. Various time-keeping software applications have been developed to replace traditional manual recordal of time on a timesheet with a view to providing a running track record of every hour or indeed every minute of billable time of service-based professionals. One of the principal drivers for this is the need to efficiently and accurately bill clients for time-related costs.

Existing software applications focus on the level of detail in recording time or automating functions to capture billable time. For example, US patent application No. 2005/0187835 describes a time tracking system that records billable time for an individual professional on a document-by-document, task-by-task, real time basis for the purpose of generating a daily billing report for that individual professional. The time tracking system monitors each newly generated document, whether Internet-based or LAN based, or each task performed by an individual professional on a daily basis.

However, not all of the time spent by a professional is billable to a client. Recording of time—whether billable or not—has recently become important to provide accountability or an audit for compliance with internal or client project reporting, invoicing or occupational health and safety compliance. Being able to identify the events associated with non-billable time is an important tool in assessing the productivity of staff and in allocating human and other resources to future projects. Whilst various companies have integrated time recordal into their project accounting systems, the need to provide increased accountability and transparency in time recordal whether billable or not has not previously been adequately addressed.

It would be advantageous if there was an alternative method, system or apparatus that facilitated the recording of time.

### SUMMARY OF THE INVENTION

In a first aspect the invention provides a method for billable timekeeping using a computer, comprising generating a time input window corresponding to an event for receiving and recording a start time and an end time for the event against an identifier; comparing the start time and end time of the event with the start time and end time of another event for the identifier; and, generating a conflict resolution input window for selection of a conflict resolution option in the event of an overlap in duration between the event and the another event.

The incorporation of the conflict resolution step into the time input procedure facilitates accurate entry of time-related costs related to the event.

In an embodiment of the invention, the conflict resolution option adjusts the start time or end time for one or both of the event and the another event. In one form this is the truncation of the event or the other event to remove the conflict. In other forms this involves the distribution of the overlapping times between the events. The prompting for user input into the conflict resolution process at the time of time entry is advantageous in that the user is contemporaneously aware of the event they just performed and they are, at that time, in an optimum position to make a judgment as to the appropriate distribution of time.

To facilitate the judgement for the user, a default option may be provided that, for example, could be predetermined to maximise the income that could be derived by the distribution of time between the conflicting events. This predetermination can take into account many factors such as the billable rates to the client for each of the event and the other event, or the current budget status of a project.

In many organisations, time entries follow a protocol where time is rounded into time increments. For example, in situations where people bill out at a high hourly rate, the time increments at which people record their time is increments of 1, 5 or 6 minutes. In contrast, larger or longer term projects may have larger time increments of 15 minute, 30 minute, 60 minutes, half days or whole days. Therefore, the method preferably limits the user to selecting a time increment that is appropriate for their organisational protocol. Also, in some circumstances, this time increment may vary according to the project or the client. In these circumstances, the organisational time increment is overridden by a time increment configured for the project or the client.

In some embodiments, the user is presented with the option of recording a billable percentage. This provides the user with the option of discounting their time as it is recorded. Discounting may apply if the user was interrupted during an event or because the type of event, client or project justifies the application of a discount of their time. To facilitate the entry of this discounting or control the extent of the discount that can be applied, the billable percentage can be limited to predetermined options as a function of the identifier. The predetermined options may be defaulted according to a protocol for a project manager, an activity, a client or a project or it can be overridden on a project or client basis.

In a multi-user environment, it is also advantageous if the method defaults the user to the currently logged in user. This, for example, prevents a user from accidentally associating their time against another user that had previously logged in.

In one embodiment of the invention, it is useful to be able to determine how much time has been spent in the production of a stored file. This information can be useful in project costing. A given stored file, for example a project report, may be worked on by a number of different users, each with different employee identifiers, with each user performing a different role such as creation of the file, editing of the file, reviewing the file or approving the file. Each of these roles may require the application of different billable percentages. As another example, if a certain type of engineering drawing is on the office system and a new project requires the creation of an engineering drawing with a similar level of technical difficultly, the time required to create the previous drawings can be used to estimate the time to create the new drawing. In many time keeping systems, it would be difficult or impossible to be able to determine the time associated with the creation of a particular file in the office system.

To provide further information to assist in the analysis of time entries, embodiments of the method can provide for the entry of an activity type. This activity type can be, for example, initial creation, review by supervisor or another appropriate category. This provides the ability to provide more accurate forecasting as well as determine where efficiencies can be gained in the business. This activity type can also be based on the current file type being worked on. For example, an email would have different activity types to a journal entry or an engineering drawing file.

The event may be recorded against client identifier which may be manually entered. Alternatively, the method of the invention may be integrated with a client management system such as a customer relationship manager or client database to provide a list of clients for selection. Similarly, the method can provide for the entry of a project identifier that is either manually entered or alternatively populated from the integration of the method with a project management system.

The manner of time entry can vary depending on the preference of the user or the style of their work. For example, some users would prefer to record their start time and then select a number of time increments whereas other users may prefer to record the end time and select the number of time increments. Alternatively, others may prefer to record the start time and end time of the event. This may vary with the type of work being done. For example, when taking a phone call it is common for the phone to display the time at the end of the call. Using this information, the user can then record the time by creating a journal entry and recording the current end time and then enter the duration of the call from the phone display. Alternatively, there may be a direct linkage to the phone system via a suitable interface. This would allow a call journal entry to be created automatically when a phone call is initiated from a selected client in a client management system and hitting a call button.

The method can be embodied in many forms. For example, it can be embodied in on a tangible medium such as a computer for performing the method steps. It can be embodied on a computer readable medium, comprising computer readable instructions for carrying out the method steps. In can also be embodied in electronic device having digital computer capabilities arranged to run the computer program on the tangible medium or execute the instruction on a computer readable medium.

In a further aspect, the invention provides a method for billable timekeeping using a computer, comprising receiving a start time and an end time for an event; receiving an identifier; determining if the start time and end time of the event conflicts with the start time and end time of another event for the identifier; and generating a conflict flag to indicate the existence of the conflict.

Embodiments of this further aspect can share one or more of the features of the first aspect of the invention.

In a further aspect, the invention provides a method for billable timekeeping using a computer, comprising generating a time input window corresponding to an event for receiving a billable percentage, a start time and an end time for the event against an employee identifier. Embodiments of this further aspect can share one or more of the features of the first aspect of the invention.

Embodiments of this further aspect can share one or more of the features of the first aspect of the invention.

Embodiments of the method according to any of the aspects of the method have particular application for environments where multiple technologies and multiple interfaces want to record time entries into a common repository. This further aspect could be implemented, for example, as a web service where an interface application can communicate via XML packets over a network to the web service to perform billable timekeeping.

### BRIEF DESCRIPTION OF THE DRAWINGS

Embodiments of the present invention will now be described by way of example only, with reference to the accompanying drawings in which:

FIG. 1 is a flow chart illustrating an embodiment of the method for billable timekeeping;

FIG. 2 is a flow chart illustrating an embodiment of the method for billable timekeeping;

FIG. 3 is a flow chart illustrating an embodiment of the method for billable timekeeping;

FIG. 4 is a block diagram of the integration of the method into an Office Automator® platform;

FIG. 5A is an exemplary embodiment of a time input window;

FIG. 5B is an exemplary embodiment of a conflict resolution window;

FIG. 5C is another exemplary embodiment of a conflict resolution window;

FIG. 6A is a flow chart illustrating an embodiment of the method for billable timekeeping incorporated into a document management system;

FIG. 6B is an exemplary embodiment of a time input window illustrating preconfigured time increments;

FIG. 6C is an exemplary embodiment of a conflict resolution window illustrating selection of an activity;

FIG. 6D is an exemplary embodiment of a conflict resolution window illustrating entering of a comment;

FIG. 6E is an exemplary embodiment of a conflict resolution window illustrating selecting a predetermined billable percentage;

FIG. 6F is an exemplary embodiment of another conflict resolution window;

FIG. 7A is a flow chart illustrating an embodiment of the method for billable timekeeping incorporated into a email system;

FIG. 7B is an exemplary embodiment of a time input window illustrating selection of a contact;

FIG. 7C is an exemplary embodiment of an email editing window illustrating providing the option to record time;

FIG. 8A is a flow chart illustrating an embodiment of the method for billable timekeeping incorporated into a phone journal system;

FIG. 8B is an exemplary embodiment of a journal input window;

FIG. 9 is a flow chart illustrating an embodiment of the method for billable timekeeping incorporated into a phone journal system;

FIG. 10A is a flow chart illustrating an embodiment of the method for billable timekeeping incorporated into a transaction management system;

FIG. 10B is an exemplary embodiment of a transaction management window; and

FIG. 11 is a block diagram of a computer device that can be used as a tangible medium for performing the method for billable timekeeping.

### DETAILED DESCRIPTION

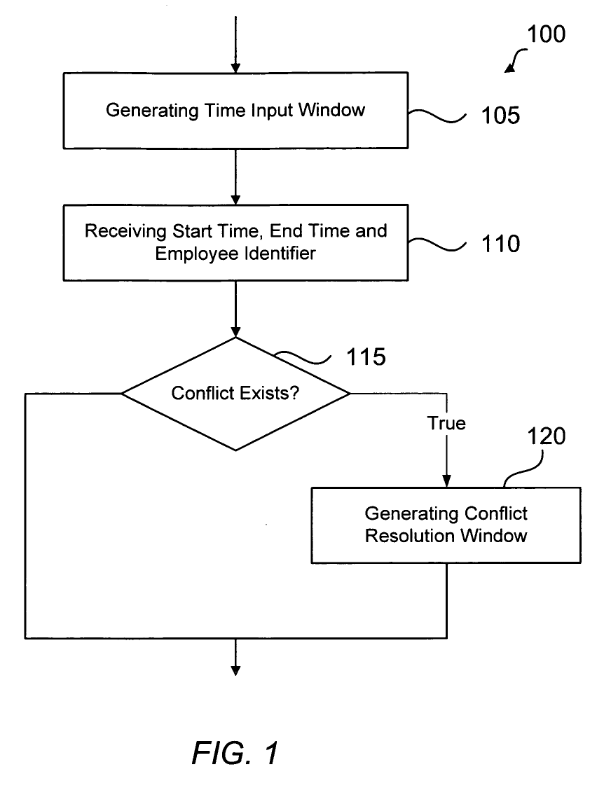

The method of the invention in its various embodiments relates to the recording of time against events and can be integrated into various computer systems. In a first embodiment illustrated in FIG. 1, the method 100 comprises the step of generating a Time Input Window 105. The Time Input Window may be generated contemporaneous with the opening or closing of a document or stored file or generated on demand. The Time Input Window 105 appears as a form in which a user can record a start time, an end time and an identifier against the event. The identifier may be an employee identifier, a client identifier, an activity identifier or a project identifier. The event could be, for example, the creation or editing of a document, the creation or editing of an email, browsing of an internet web site or an incoming or outgoing phone call. The event start time and end time can be defaulted to the start and/or end of the event if the system in which the method is embodied can facilitate this functionality. Alternatively, the user would manually select the start and/or end time manually using the Time Input Window 105.

The method 100 then comprises the step of comparing the start time and end time of the event with the start time and end time of another event for the employee identifier to determine if there is a conflict. A conflict exists if there is an overlap between the start or end times of the event being recorded and another event previously recorded against the employee identifier. If it is determined that there is a conflict 115, a conflict resolution window 120 is generated. The user can then select a conflict resolution option from a list of one or more options presented in the conflict resolution window. The selection of one of these conflict resolution options provides enough information such that any conflict can be resolved.

It is highly advantageous to be able to identify and resolve conflicting time entries to effectively “cleanse” or “screen” the data contemporaneously as the time entry data is being stored in a database. This eliminates the need to run conflict reports or alert procedures on a large volume of entered data at a later time, which can be highly demanding of CPU and memory capacity. Performing the cleansing function each time that new time entries are being recorded distributes the load on the computer system over time. Also, from a user perspective, it is easier to make a decision about which conflict resolution option is most appropriate to the task at hand when recording time entries against an event contemporaneously rather than at some time down the track. If conflict reports or alerting procedures are not regularly executed, the user would otherwise be required to cast their mind back to the time at which they performed the work which could be days or weeks in the past. Moreover, cleansing of the data allows for the information stored in a database against the event or against a project or client identifier to be made available “live” to a client, for example, secure in the knowledge that if the information is audited, no overlapping time entries will be detected. This also reduces the time required to process time data in order to complete invoice generation or project reporting. Preferably a default action occurs if the user does not resolve the conflict in time entries, i.e. if they try to avoid the issue. The default action may be, for example, to truncate the other event to remove the conflict.

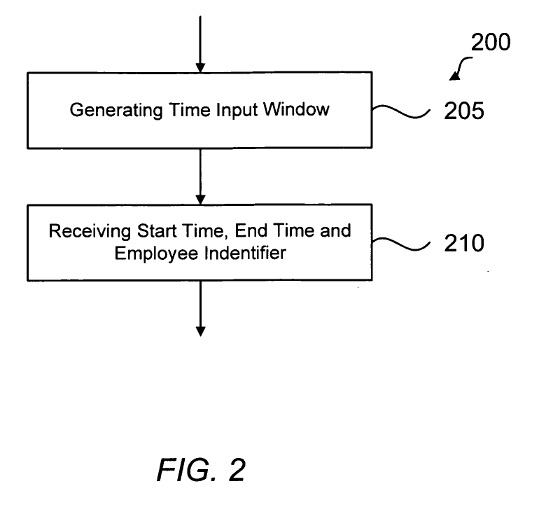

Referring to FIG. 2, a second embodiment of the method 200 involves the step of generating a time input window 205 and then the step of receiving from this time input window the start time, end time and an employee identifier 210 associated with an event. In this embodiment, the method 200 also involves the step of associating the event with a stored file, the stored file having other data, for example, a client identifier and/or a project identifier. The association of the event with the stored file allows the information associated with the stored file to be used as information recorded against the event.

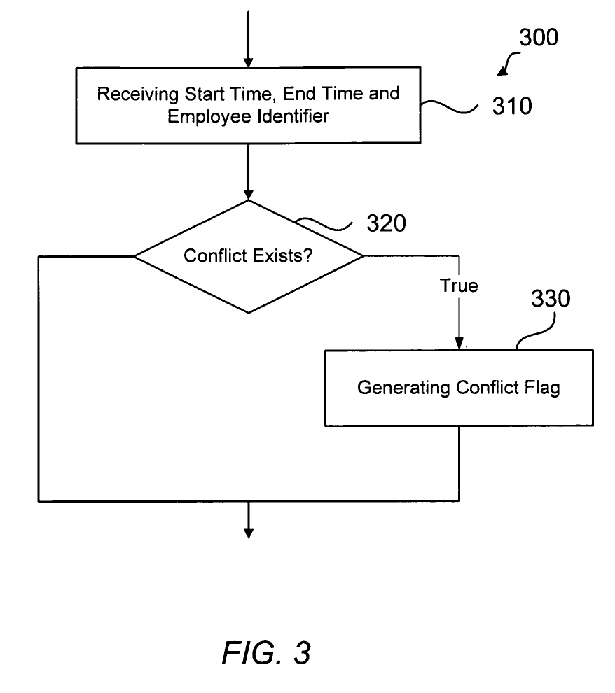

Referring to FIG. 3, another embodiment of the method 300 involves the step of receiving a start time and an end time for an event as well as receiving an identifier 310. With this information, a comparison step 320 can determine if there are any other events that overlap with the start and end time being received and recorded for the event. By performing this comparison it can be determined if there is a conflict due to the existence of overlapping time entries for the identifier. The identifier can represent an employee, an activity type, a client or a project. However, it can also represent other resources or objects that it would be desirable to prevent the overlapping of time records. For example, this mechanism would be applicable to the booking of meeting rooms or other physical resources. If there is a conflict, the system can perform the step of generating a conflict flag to indicate that a conflict existed 330. The conflict flag displays at least one conflict resolution option.

An embodiment of method 300 may be in the form of an XML web service or database procedure that receives data in the form of a request from an interface layer, processes the request and transmits back a conflict resolution flag for use by the application layer. This embodiment has particular application in the implementation of the system in an internet environment where, for example, a web browser provides the interface layer.

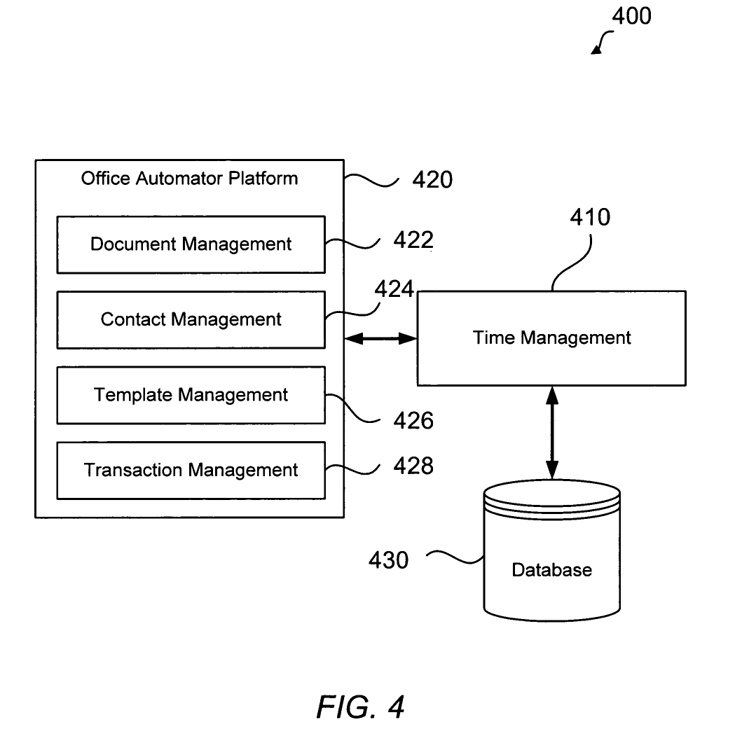

An exemplary embodiment of the method 400 in the form of a time management component 410 integrated with an office automation platform 420 is illustrated in FIG. 4. The time management component 410 uses a database 430, for example, a Microsoft® SQL database to store data and process database requests. The office automation platform 420 includes several sub-components such as a document management system 422, a contact management system 421, a template management system 426 and a transaction management system 428. Each sub-component could operate independently as a stand alone system, but the advantages of integrating these components as a single system will become apparent in the discussion to follow.

The time management component 410 operates in several contexts in which time is recorded in accordance with embodiments of the present invention. These various contexts included entering time when creating or reviewing a document, making journal entries associated with contacts, sending email messages or creating or reviewing a file in a transaction system. The time management component 410 also allows the entering of time in isolation of such an association such as a document.

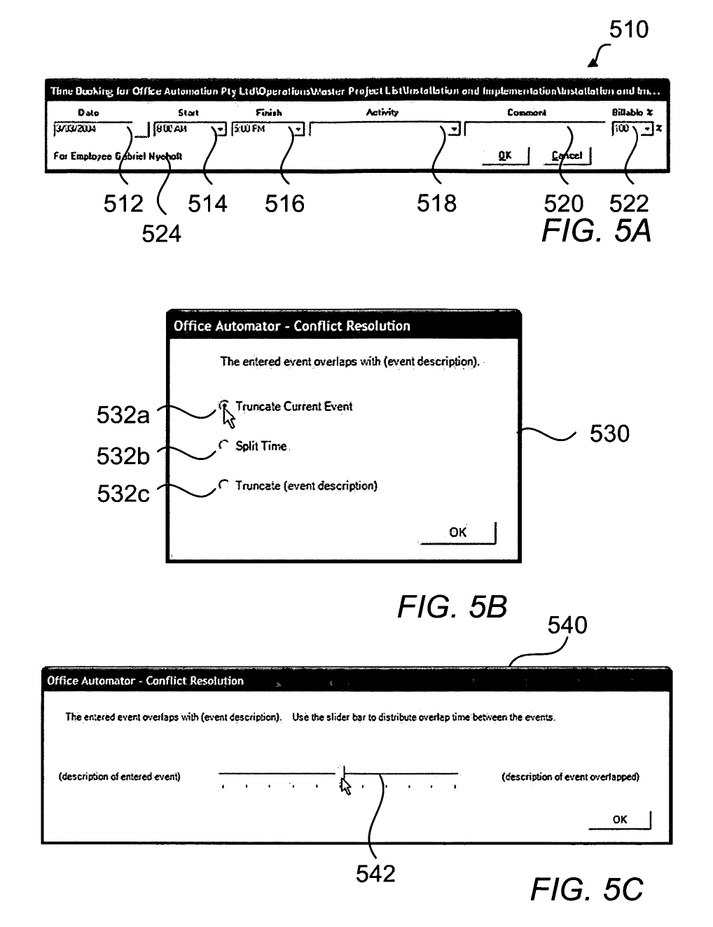

Referring to FIG. 5, a time input window and two alternate conflict resolution windows are exemplified in the form of graphical user interfaces developed in Microsoft® Visual Basic. In general, the time input window can be implemented in any number of ways.

FIG. 5A illustrates a time input window 510 which has an event date control 512, an event start time combo box 514, an event end time combo box 516, an activity combo box 518, a comment text box 520 and a billable percentage combo box 522. The employee identifier 524 can be selected prior to the display of the time input window 510 or alternatively defaulted to the user that is logged onto the session in which the time input window is operating. In this regard, the start time and end time need not be received and recorded by the user who corresponds to an employee identifier but could equally be entered by another user, for example, a secretary, an administrative assistant, or a supervisor with authority to decide on the conflict resolution options. The time input window 510 is utilised in several contexts of the embodiment of the time management component 400.

FIG. 5B and 5C provide two possible embodiments of a conflict resolution input window. FIG. 5B is a conflict resolution input window 530 that uses radio buttons 532 to allow the user to select a conflict resolution option. Selecting the radio button 532a results in the time entry for the event currently being entered to be truncated, leaving the conflicting event unamended. Alternatively, selecting the radio button 532c leaves the event currently being entered unamended and updates the conflicting event so that it is truncated. The option provided by radio button 532b evenly splits the overlapping time period between each of the events and therefore amends the time recorded against the event currently being entered as well as the time recorded for the conflicting event.

Other radio button options may also be displayed. For example, if one of the events was wholly contained with the other, two options could be presented for either moving the contained event to the beginning or the end of the other event. Another option would also be the replacement of the overlapped period in the other event with the event currently being entered, essentially splitting the other event into two discrete events with the event currently being entered in between.

FIG. 5C is an alternate conflict resolution window 540 in which a trackbar control 542 allows for control of the distribution of overlap time between the conflicting events. With the trackbar control 542, the overlap time can be distributed according to preconfigured time increments of, for example, 6 minute blocks. If there was 36 minutes of overlap, the trackbar control 542 could be generated to provide 6 incremental selections along its length. In this example, the increments would allow the user to select anywhere between 0 and 36 minutes of the overlap to be attributed to the event currently being entered. A variety of other time increments may be provided, for example, days, half days, etc.

With various forms of conflict resolution window, the option that is selected by default can be determined based on certain criteria. In one form, the time could be, by default, assigned to the event that would generate the most revenue. For example, if one event was completely billable time and the other was only partially billable, the time would be defaulted so that the overlap is assigned to the completely billable time. In another form, the database may include a plurality of business rules which may dictate the way in which conflict resolution is achieved depending on the role of the employee identifier, the type of project or the type of event.

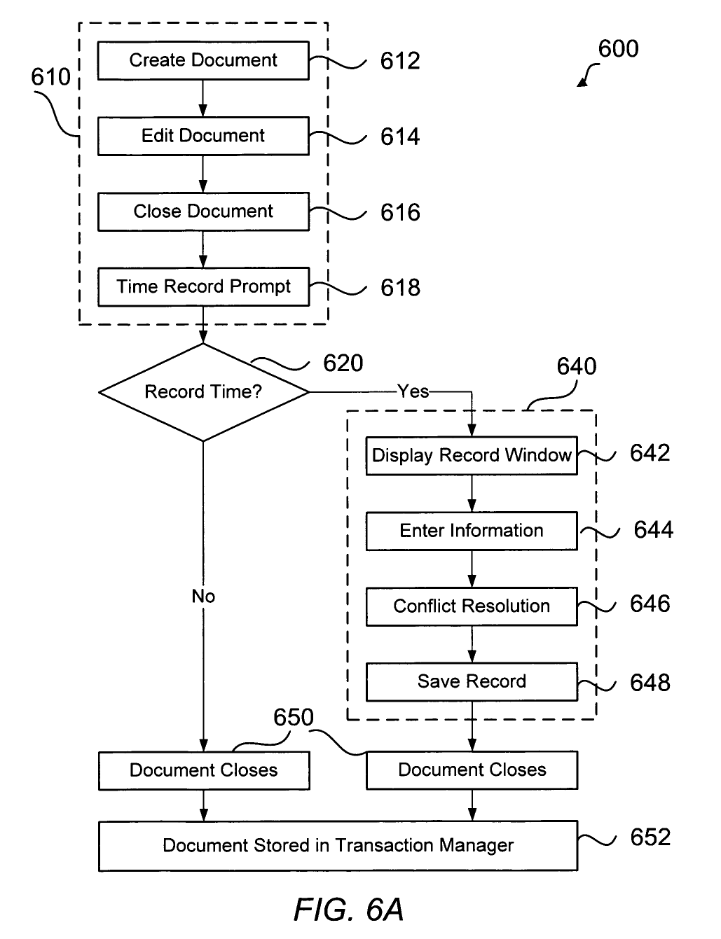

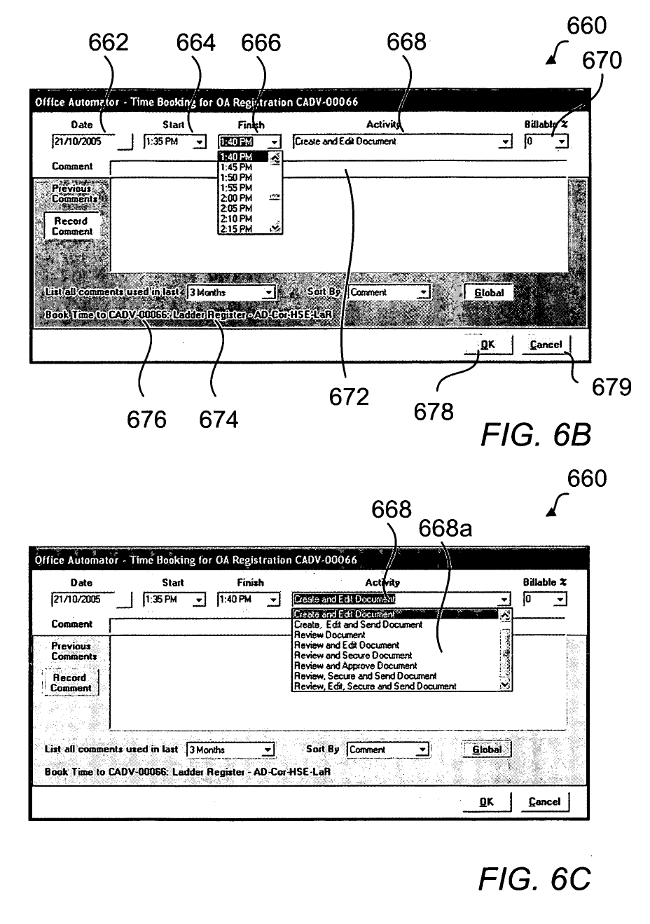

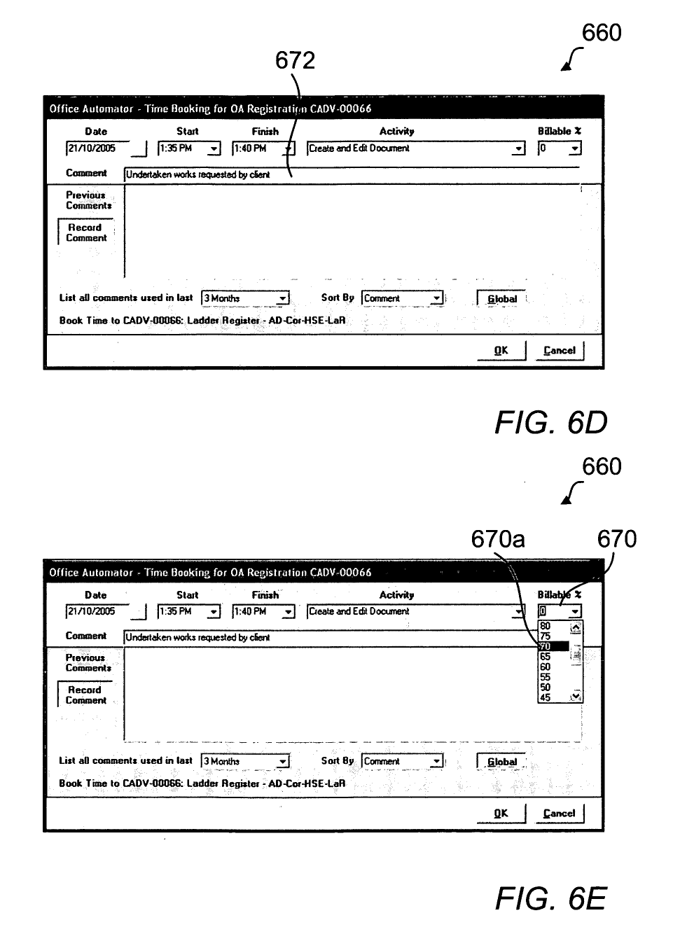

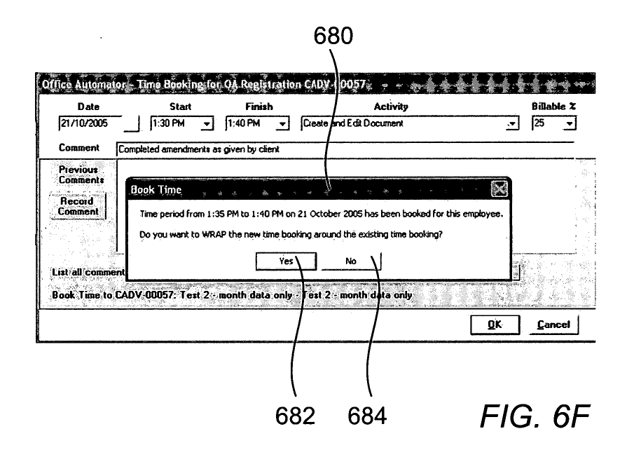

With the embodiments of the method for billable timekeeping embodied in the time management component 410 that is integrated with an office automation platform 420, the overall process includes three main stages: (a) triggering an event or recording operation; (b) associating the event with various identifiers; and (c) performing the timekeeping steps. In FIG. 6 to 10, the steps associated with each of these stages are grouped together by dashed boxes for ease of diagram interpretation. Similarly, they are referred to as stages in the description below for ease of understanding.

With reference to FIG. 6A, an embodiment of the method for billable timekeeping 600 is incorporated into a document management system 422. The first stage in this process in the document event stage 610. When the document is created at step 612, a file model identifier and a file node identifier are already associated with the document. The document is edited at step 614 and then a document closing event is triggered at step 616. On detection of the document closing event, the document management system then prompts the user at step 620 to ask if they want to record the time.

If time recording is requested, the timekeeping stage 640 begins. The timekeeping stage 640 involves the step of generating a time recording window 642 and the step 644 of the user entering information into the time recording window. The next step 646 is a determination if there is a conflict in the form of a time overlap with an existing event. If there is a conflict, the method then generates a conflict resolution window. The user can then select a conflict resolution option from a list of one or more options presented in the conflict resolution window. After this conflict resolution step, which may or may not actually trigger a conflict resolution window, the time record is saved in the next step 648.

Following the timekeeping stage 640, the method for billable timekeeping 600 continues with the steps it would have taken if the user had not selected the option of time recording. These next steps are the closing of the document application 650 and the step 652 of storing of the document in the transaction management system.

FIG. 6B to 6E illustrate the entry of information into a time input window 660. Each of these diagrams illustrates the same window in different states of information input.

FIG. 6B shows the selection of the end time in preconfigured time increments with a combo box 666. The start time is also limited to the preconfigured time increments with a combo box 664. The duration of these time increments is saved as a parameter in a configuration file for the time management component 410. In the illustrated embodiment, these time increments are 5 minutes in duration. However many other increments could be configured such as 1 minute, 6 minutes, 15 minutes, 30 minutes, 60 minutes, 2 hours, a half day or whole days in duration.

As the stored document file has already had associated with it the file model identifier and the file node identifier, these are not required to be entered by the user and are displayed as text labels 674 and 676. This integration of the transaction management component 426, the document management component 422 and the time management system 410 reduces the number of times a user has to re-enter information and facilitates the workflow between each of the components. The integration of components also reduces data redundancy between components and therefore reduces the capacity of storage necessary to host the system.

The time management component 410 is not limited to associating with text documents. The time management component 410 can have associations with different types of files including technical drawings, spreadsheets or media files. The time management component 410 could equally be associated with a list of activities related to the Work Breakdown Structure (WBS) for a project or associated with other project management software.

FIG. 6C illustrates selection of an activity from a list 668a in a combo box 668. In this embodiment, the integration of the system with the transaction management component also allows the time input window 660 to populate the combo box 668 with a context sensitive list of combo box options.

FIG. 6D illustrates the entering of a comment into a text box 672.

FIG. 6E illustrates selecting a billable percentage increment from a predetermined list of options. This billable percentage increment is saved as a parameter in a configuration file for the time management component 410. In this embodiment, the increment is set to increments of 5 percent. In some user environments, such a small increment may not be appropriate and other increments such as 10, 20, 25 or 50 percent may be more appropriate. The selection may also limit the discount, for example, to 50 percent.

Following the entering of the information and continuing using the OK button 678, the next step is the conflict resolution step 646. In this specific example, there was a conflicting time record already on the system and FIG. 6F illustrates a conflict resolution window that has been generated as a result. This conflict resolution window only provides two options. The Yes button 682 amends the current time entry to wrap around the existing time entry whereas the No button 684 results in the existing time record being amended to remove the conflict.

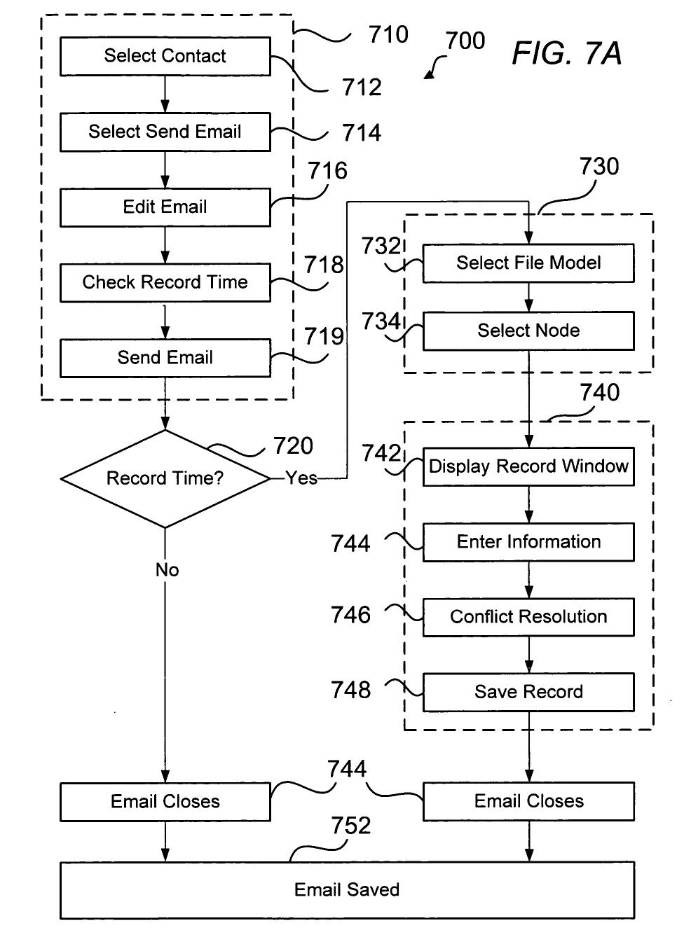

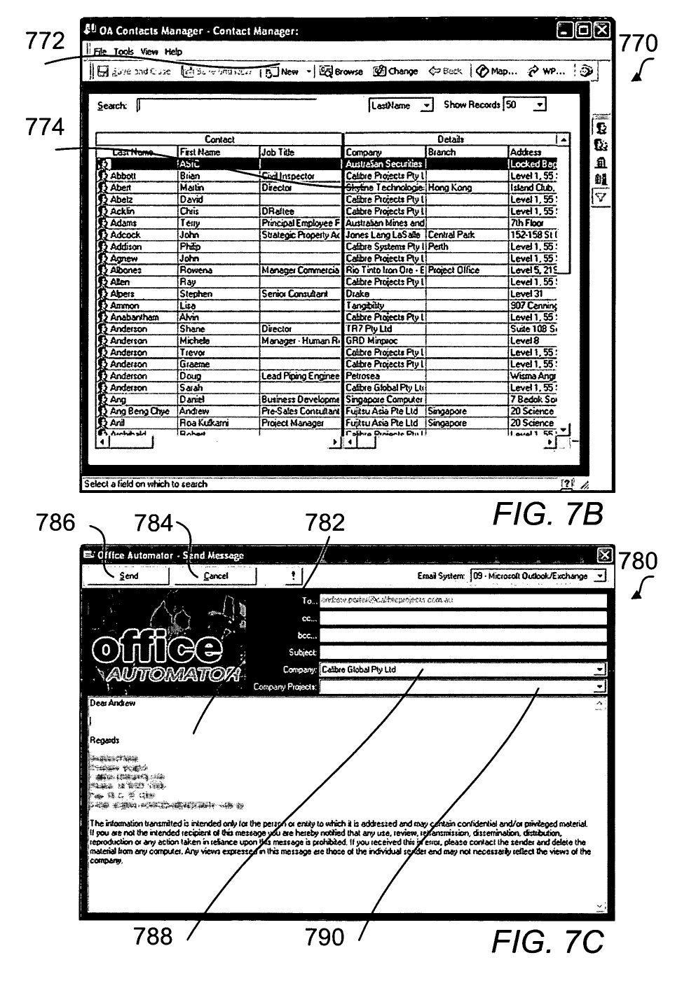

With reference to FIG. 7A, an embodiment of the method for billable timekeeping 700 is incorporated into a contact management system 424. The first stage in this process in the contact event stage 710. In this stage, the first step 712 is the selection of a contact that will be sent an email message and then selecting the option of sending the contact an email according to step 714. In the next step 716, the email is edited in a conventional editing interface. Before sending the email, the user has the option of performing step 718 in which he or she requests that time be recorded against the e-mail. Upon performing the step 719 of sending the email, step 720 occurs in which the contact management system checks if time is to be recorded.

In this example, if time recording is requested, a file model identifier and a file node identifier are yet to be assigned to the email transaction. Therefore, the stage 730 where the event is associated with various identifiers occurs. In this stage, an interface allows the user to select the file model identifier and the file node identifier. Once the association stage is complete the timekeeping transaction stage 740 commences. The timekeeping transaction stage 740 involves similar steps as described in the previous timekeeping stage 640. However, it is to be appreciated by the skilled person that many possible time input windows and conflict resolution windows may be used including those already illustrated in FIG. 5 and 6.

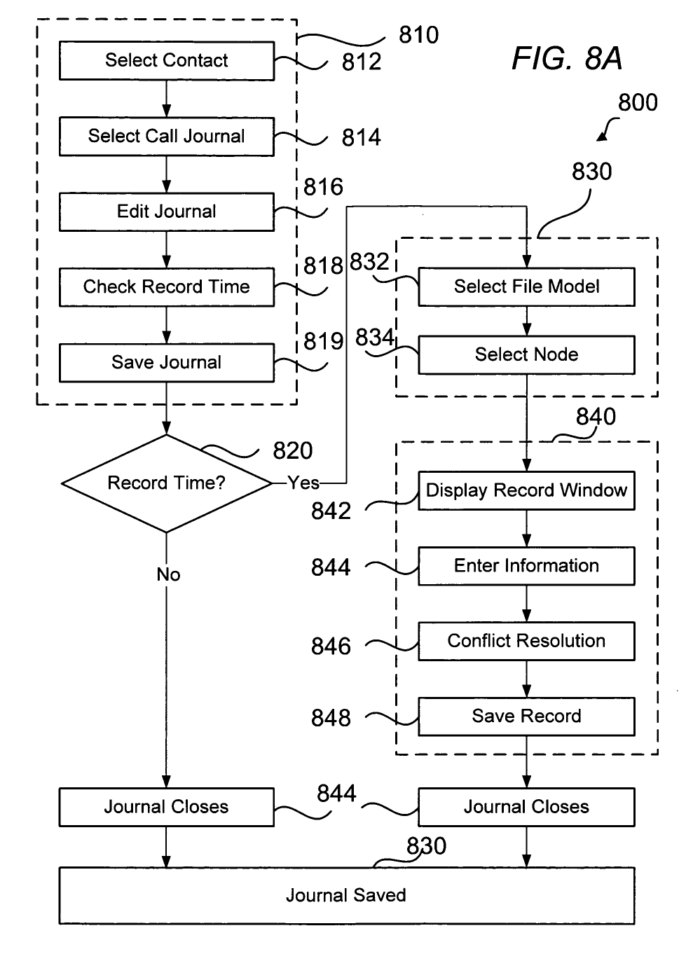

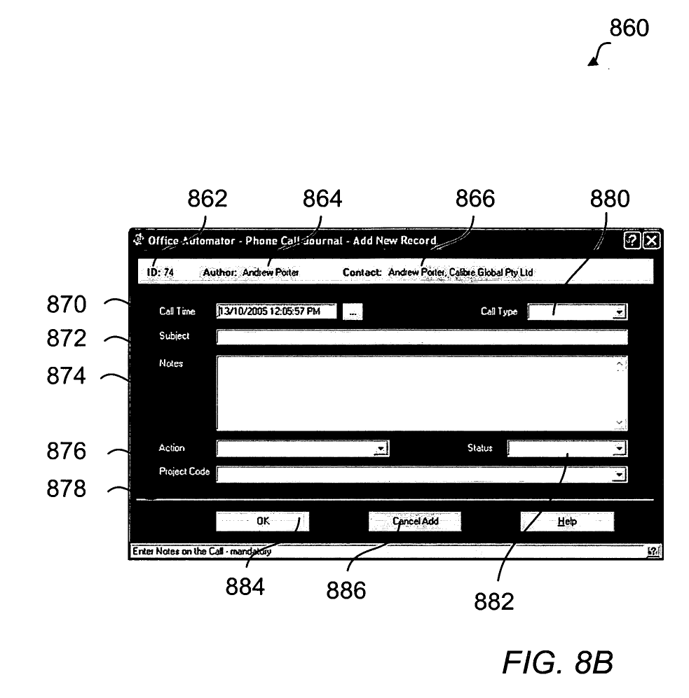

With reference to FIG. 8A and 8B, an embodiment of the method for billable timekeeping 800 is incorporated into a contact management system 424. This embodiment shares many features of the method for billable timekeeping 700 incorporated into a contact management system. In this embodiment, the association stage 830 and the timekeeping transaction stage 840 can re-use the similar association 730 and timekeeping transaction 740 sub components that were used in the billable timekeeping embodiment 700.

The first stage in the journal time recording process is the contact event stage 810. In this stage, the first step 812 is the selection of a contact that a journal entry will be recorded for and then selecting the option of recording the call journal entry according to step 814. This portion of the process uses the same interface illustrated in FIG. 7B.

In the next step 816, the journal entry is edited in a journal window 860. The user can edit the call start time text box 870 as well as the other fields such as subject 872, journal notes 874, journal status text box 882 and call type select box 880. The user can then exit the journal window, by selecting the OK button 884 or the CancelAdd button 886. If the user presses the CancelAdd button 866, the record is not saved. If the OK button 884 is selected, the step 819 of sending the journal occurs, and then the step 720 occurs in which the journal management system checks if time is to be recorded. If time is to be recorded, the association stage 830 and the timekeeping transaction stage 840 are performed.

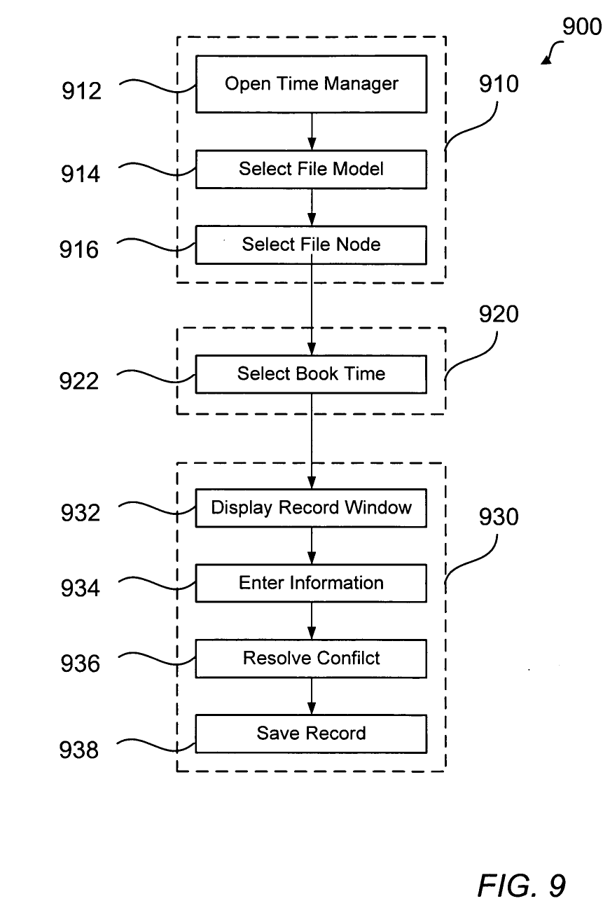

With reference to FIG. 9, an embodiment of the method for billable timekeeping 900 is incorporated into a transaction management component 428 that allows association of time with a file node without an association with an object such as a document, a contact or an email. In this embodiment, the association operation 910 is done by the user performing the step 912 of opening the time manager console and then selecting from the hierarchy a file model 914 and a file node 916. The event stage 920 is then done by using the interface to right click on the file node and performing the step 922 of selecting the option of booking a time associated with the file node. The timekeeping transaction stage 930 involves similar steps as described in the previous timekeeping stage 640.

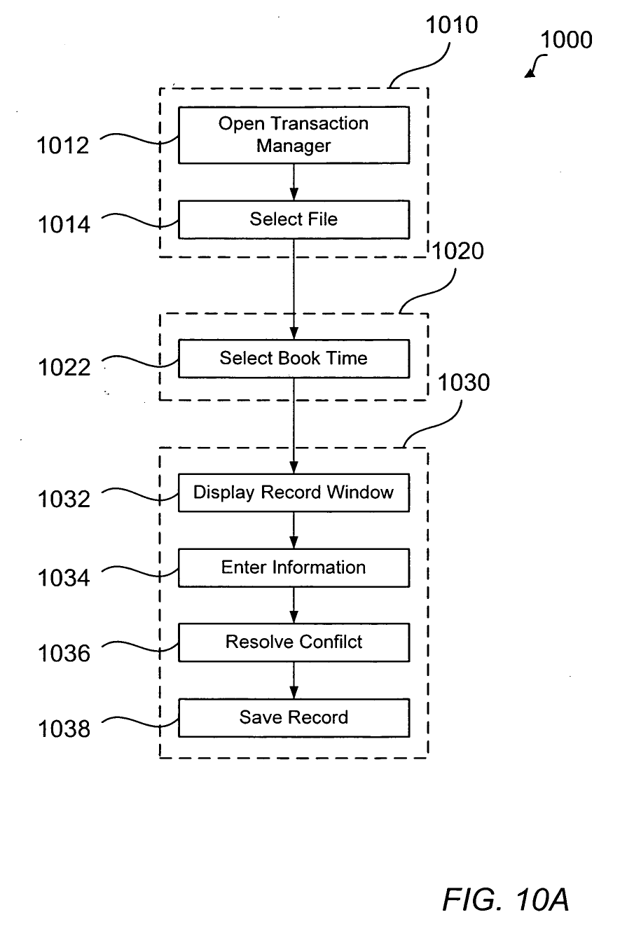

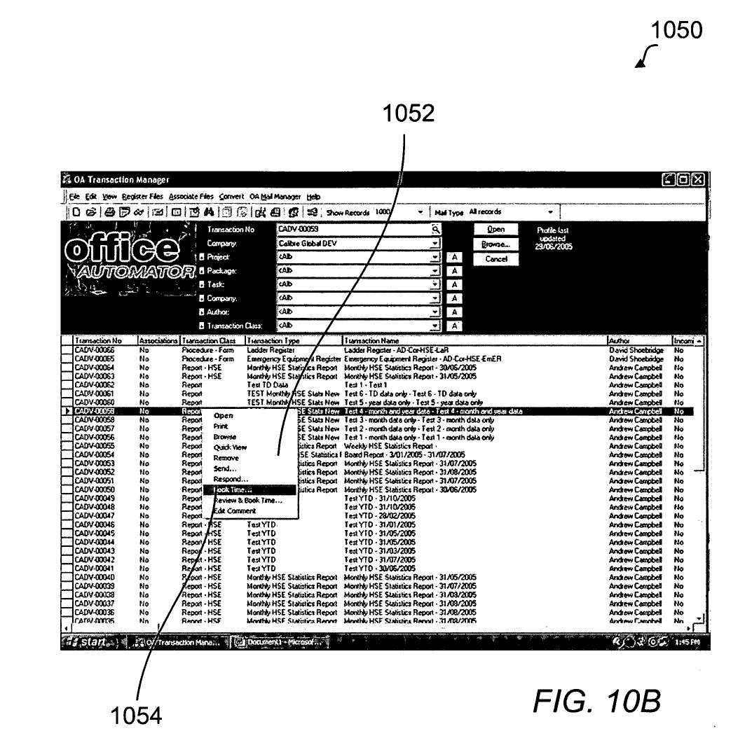

With reference to FIG. 10A, an embodiment of the method for billable timekeeping 1000 is incorporated into a system component that allows association of time with a file. This file is already associated with a file model and a file node. This embodiment allows files such as engineering drawings to have time associated with them. The user interface window for the association step is illustrated in FIG. 10B.

In this embodiment, the association stage 1010 involves the steps of opening the transaction manager 1012 and then selecting the file 1014 to be associated with the timekeeping entry. In the next event triggering stage 1020, the event is triggered by using the interface as illustrated in FIG. 10B to right click on the file node to show the context menu 1052 and performing the step 1022 of booking time against the file by selecting the book time option 1054. The timekeeping transaction stage 1030 involves similar steps as described in the previous timekeeping stage 640.

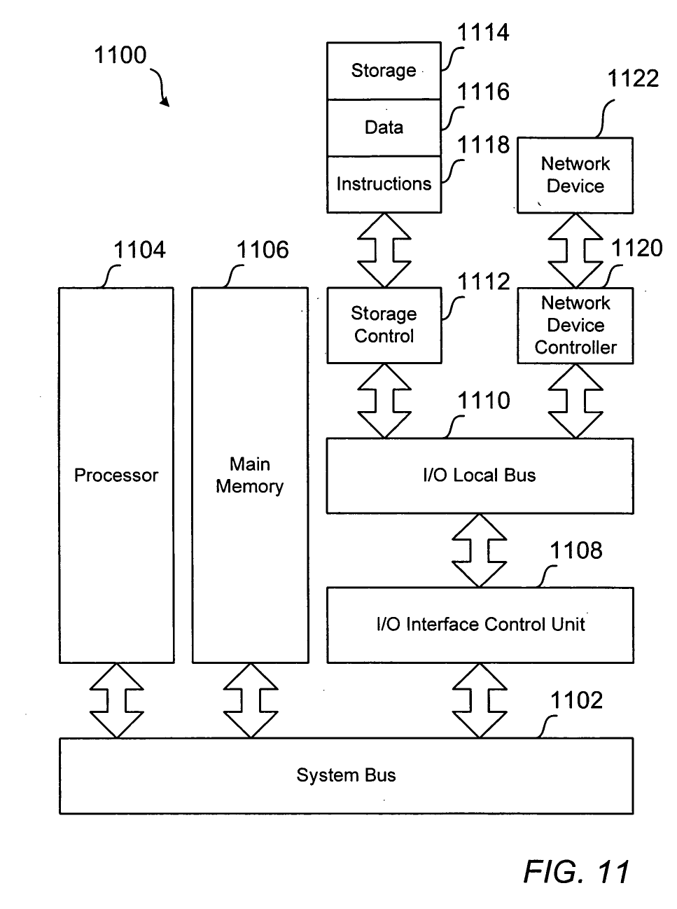

FIG. 11 is a block diagram 1100 of a data processing apparatus suitable for hosting a time management component in accordance with an exemplary embodiment of the present invention. The data processing apparatus includes a processor 1104 operatively coupled to a main memory 1106 by a system bus 1102. The processor 1104 may load programming instructions into the main memory 1106. The programming instructions are executable by the processor 1104 to implement the steps of a billable timekeeping method as described herein.

The processor 1104 may further be coupled to a storage device 1114 through an Input/Output (I/O) control unit 1108, an I/O local bus 1110, and a storage device controller 1112. The storage device 1114 may be used to store the programming instructions 1118 and any data 1116 used by the processor 1104 to implement the features of a billable timekeeping method.

The processor 1104 may further be coupled to a network device 1122 via the Input/Output (I/O) control unit 1108, the I/O local bus 1110, and a communications device controller 1120. The processor 1104 may then communicate with other data processing systems, for example, to transmit conflict resolution information or receive conflict flags, as desired to implement the features of a billable timekeeping method as described herein.

An exemplary embodiment of the invention may be implemented on computing device (s), processor (s) 1104, computer (s) and/or communications device (s).

The computer, in an exemplary embodiment, may comprise one or more central processing units (CPUs) or processors, which may be coupled to the bus 1102. The processor 1104 may, e.g., access the main memory 1106 via the bus 1102. The computer may be coupled to an input/output (I/O) control unit 1108 such as, but not limited to, a network interface 1122 in the form of a network interface card (NIC), or a modem for access to a network.

In the following description and claims, the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

The computer may also be coupled to a secondary memory 1114 via I/O control unit 1108 directly via a bus (not shown), or via a main memory 1106, for example. Secondary memory 1114 may include, e. g., but not limited to, a disk storage unit or other storage medium. Exemplary disk storage units 1114 may include, but are not limited to, a magnetic storage device such as, e. g., a hard disk, an optical storage device such as, e. g., a write once read many (WORM) drive, or a compact disc (CD), a digital versatile disc (DVR), or a magneto optical device. Another type of secondary memory may include a removable disk storage device, which may be used in conjunction with a removable storage medium, such as, e. g. a CD-ROM, DVD-ROM, or a floppy diskette. In general, the disk storage unit may store an application program for operating the computer system referred to commonly as an operating system. The disk storage unit may also store documents of a database (not shown). The computer may interact with the I/O subsystems and disk storage unit via bus. The bus may also be coupled to a display for output, and input devices such as, but not limited to, a keyboard and a mouse or other pointing/selection device.

In this document, the terms “computer program medium” and “computer readable medium” may be used to generally refer to media such as, e.g., but not limited to removable storage drive, a hard disk installed in hard disk drive, and signals, etc. These computer program products may provide software to computer system. The invention may be directed to such computer program products.

References to “one embodiment”, “an embodiment”, “example embodiment”, “various embodiments”, etc, may indicate that the embodiment (s) of the invention so described may include a particular feature, structure, or characteristic, but not every embodiment necessarily includes the particular feature, structure, or characteristic.

Further, repeated use of the phrase “in one embodiment” or “in an exemplary embodiment”, do not necessarily refer to the same embodiment, although they may.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supported by this application and the claim equivalents rather than the foregoing description. It will be clearly understood that a reference to prior art publications or use herein does not constitute an admission that such material forms part of the common general knowledge in the art, in Australia or in any other country.

1. A method for billable timekeeping using a computer, comprising:
generating a time input window corresponding to an event for receiving and recording a start time and an end time for the event against an identifier;
comparing the start time and end time of the event with the start time and end time of another event for the identifier; and,
generating a conflict resolution input window for selection of a conflict resolution option in the event of an overlap in duration between the event and the another event.

2. A method for billable timekeeping according to claim 1, wherein the conflict resolution option comprises adjusting the start time or end time for one or both the event or the another event

3. A method for billable timekeeping according to claim 1, wherein the conflict resolution option comprises truncation of the event to remove the conflict.

4. A method for billable timekeeping according to claim 1, wherein the conflict resolution option comprises truncation of the another event to remove the conflict.

5. A method for billable timekeeping according to claim 1, wherein the conflict resolution option comprises the option of distributing the overlap in duration between the event and the another event to remove the conflict.

6. A method for billable timekeeping according to claim 1, wherein the conflict resolution option selected on the conflict resolution input window defaults to a predetermined option as a function of the identifier.

7. A method for billable timekeeping according to claim 1, wherein the duration of an event is limited to configurable time increments.

8. A method for billable timekeeping according to claim 7, wherein the configurable time increment is one of a 1 minute, a 5 minute, a 6 minute, a 15 minute, a 30 minute, a 60 minute, a half day or a full day increment.

9. A method for billable timekeeping according to claim 1, further comprising receiving a billable percentage for the event from the time input window.

10. A method for billable timekeeping according to claim 9, wherein the billable percentage is limited to a predetermined option as a function of the identifier.

11. A method for billable timekeeping according to claim 9, wherein the billable percentage is limited to a predetermined option as a function of the event.

12. A method for billable timekeeping according to claim 1, wherein the event is associated with a stored file.

13. A method for billable timekeeping according to claim 12 wherein the identifier is an activity type selected based on the stored file.

14. A method for billable timekeeping according to claim 1, wherein the identifier is an employee identifier and the employee identifier is defaulted to a currently logged in user.

15. A method for billable timekeeping according to claim 1, wherein the identifier is a client identifier.

16. A method for billable timekeeping according to claim 15, further comprising integrating with a client management system to provide a list of clients for selection of the client identifier.

17. A method for billable timekeeping according to claim 1, wherein the identifier is a project identifier.

18. A method for billable timekeeping according to claim 17, further comprising integrating with a project management system to provide a list of projects for selection of the project identifier.

19. A method for billable timekeeping according to claim 1, wherein the end time is input as time increments from the start time.

20. A method for billable timekeeping according to claim 1, wherein the method is implemented using a plurality of interfaces to record time entries in a common database.

21. A method for billable timekeeping according to claim 1, wherein the method is implemented as a web service and an interface application communicates via XML packets over a network to the web service to perform billable timekeeping.

22. A computer program arranged on a tangible medium for performing the method steps defined in claim 1.

23. A computer program according to claim 22 embodied on a computer readable medium comprising computer readable instructions for carrying out the method steps when run by an electronic device having digital computer capabilities.

24. An electronic device having digital computer capabilities arranged to run the computer program according to claim 22.

25. A method for billable timekeeping using a computer, comprising:
receiving a start time and an end time for an event;
receiving an identifier;
determining if a conflict exists between the start time and end time of the event and the start time or end time of another event for the identifier; and
generating a conflict flag to indicate the existence of the conflict.

26. A method for billable timekeeping according to claim 25, wherein the conflict flag encapsulates at least one conflict resolution option for selection.

27. A method for billable timekeeping according to claim 26, wherein the or each conflict resolution option comprises adjusting the start time or end time for one or both the event or the another event.

28. A method for billable timekeeping according to claim 26, wherein one of the conflict resolution options encapsulated in the conflict flag includes the option of truncating the event to remove the conflict.

29. A method for billable timekeeping according to claim 26, wherein one of the conflict resolution options displayed on the conflict resolution input window includes the option of truncating the another event to remove the conflict.

30. A method for billable timekeeping according to claim 26, wherein one of the conflict resolution options displayed on the conflict resolution input window includes the option of distributing the overlap time between the events to remove the conflict.

31. A method for billable timekeeping according to claim 36, wherein the conflict resolution option is defaulted to a predetermined option as a function of the identifier.

32. A method for billable timekeeping according to claim 31, wherein the identifier is a client identifier, an employee identifier or a project identifier.

33. A method for billable timekeeping according to claim 25, wherein the method is implemented using a plurality of interfaces to record time entries in a common database.

34. A method for billable timekeeping according to claim 25, wherein the method is implemented as a web service and an interface application communicates via XML packets over a network to the web service to perform billable timekeeping.

35. A computer program arranged on a tangible medium for performing the method steps defined in claim 25.

36. The computer program according to claim 35 embodied on a computer readable medium, comprising computer readable instructions for carrying out the method steps when run by an electronic device having digital computer capabilities.

37. An electronic device having digital computer capabilities arranged to run the computer program according to claim 35.

38. A method for billable timekeeping using a computer, comprising generating a time input window corresponding to an event for receiving billable percentage, a start time and an end time for the event against an employee identifier.

39. A method for bill able timekeeping according to claim 38, wherein the event is associated with a stored file.

40. A method for billable timekeeping according to claim 39, further comprising receiving an activity type from the time input window.

41. A method for billable timekeeping according to claim 40, wherein an activity type option is selectable based on the stored file.

42. A method for billable timekeeping according to claim 38 wherein the identifier is a client identifier, an employee identifier or a project identifier.

43. A method for billable timekeeping according to claim 42, wherein the identifier is a client identifier and the method further comprises integrating with a client management system to provide a list of clients for selection of the client identifier.

44. A method for billable timekeeping according to claim 42, wherein the identifier is a project identifier and the method further comprises integrating with a project management system to provide a list of projects for selection of the project identifier.

45. A method for billable timekeeping according to claim 44, wherein the duration of the event is limited to configurable time increments.

46. A method for billable timekeeping according to claim 45, wherein the configurable increment is one of a 1 minute, a 5 minute, a 6 minute, a 15 minute, a 30 minute, a 60 minute, a half day or a full day increment.

47. A method for billable timekeeping according to claim 38, wherein the end time is input as time increments from the start time.

48. A method for billable timekeeping according to claim 38, wherein the method is implemented using a plurality of interfaces to record time entries in a common database.

49. A method for billable timekeeping according to claim 38, wherein the method is implemented as a web service and an interface application communicates via XML packets over a network to the web service to perform billable timekeeping.

50. A computer program arranged on a tangible medium for performing the method steps defined in claim 38.

51. The computer program according to claim 50 embodied on a computer readable medium, comprising computer readable instructions for carrying out the method according to claim 38 when run by an electronic device having digital computer capabilities.

52. An electronic device having digital computer capabilities arranged to run the computer program according to claim 50.
